(19) United States
(12) Patent Application Publication
(10) Pub. No.: US 2009/0214971 A1
(43) Pub. Date: Aug. 27, 2009

(54) HYBRID DEVELOPING METHOD USING SPECIFIED DEVELOPER AND IMAGE-FORMING APPARATUS USING THEREOF

(75) Inventors: Eiichi Yoshida, Hino-shi (JP); Makoto Kobayashi, Koganei-shi (JP); Kazue Nakamura, Hino-shi (JP)

Correspondence Address: BUCHANAN, INGERSOLL & ROONEY PC, POST OFFICE BOX 1404, ALEXANDRIA, VA, 22313-1404, US

(73) Assignee: Konica Minolta Business Technologies, Inc., Chiyoda-ku (JP)

(21) Appl. No.: 12/369,138

(22) Filed: Feb. 11, 2009

(30) Foreign Application Priority Data
Feb. 12, 2008 (JP) 2008-030003

(51) Int. Cl. G03G 13/06; G03G 15/08

(52) U.S. Cl. 430/97; 399/253

(57) ABSTRACT

An image-forming method includes a process in which a toner is supported and transported on the surface of a toner supporting member placed face to face to an electrostatic latent image-supporting member, and electrostatic latent images formed on the electrostatic latent image-supporting member is developed by the toner; and a process in which a two-component developer containing the toner and a carrier is supported on the surface of a developer-supporting member placed face to face to the toner supporting member and the toner is supplied onto the toner-supporting member. The developer includes toner particles containing a binder resin and a colorant; a carrier charging the toner particles in friction-contact with the toner particles; and reverse polarity particles and homopolarity particles respectively charged to polarity reversed to and the same polarity as polarity of the toner particles charged in friction-contact with the carrier.

This application is based on application(s) No. 2008-030003 filed in Japan, the contents of which are hereby incorporated by reference.

### BACKGROUND OF THE INVENTION

1. Technical Field

The present invention relates to a developer and an image-forming apparatus that are suitably used for a hybrid developing system.

2. Background Art

With respect to the developing system used for an image-forming apparatus of an electrophotographic system, a mono-component developing system that uses only the toner as its main component for a developer and a two-component developing system that uses a toner and a carrier as its main components for a developer have been known.

A developing device of the mono-component developing system is provided with a toner supporting member that supports a toner so as to be transported and a frictional charging member that is made in contact with the toner supporting face of the toner supporting member. The toner, supported on the toner supporting member, is made in friction-contact with the frictional charging member to be formed into a thin film and also charged into a predetermined polarity, upon passing through a contact position with the frictional charging member. In this manner, since the mono-component developing device carries out a charging process of the toner by allowing the toner to be made in friction-contact with the frictional charging member, it has advantages in that the structure is simple, small and inexpensive. However, since the toner is subjected to a strong stress at the contact position with the frictional charging member, the toner tends to easily deteriorate, impairing electrostatic property of the toner in a comparatively early stage. Moreover, by a contact pressure exerted between the toner supporting member and the frictional charging member, the toner tends to adhere to the two members, causing reduction in the charging capability of the toner, with the result that the service life of the developing device becomes comparatively shorter.

In the case of the developing device of the two-component developing system, since the toner and the carrier are made friction-contact with each other to be charged into predetermined polarities, the stress to be applied to the toner is comparatively smaller than that in the mono-component developing system. Since the carrier also has a larger surface area in comparison with that of the toner, it is less susceptible to toner adhesion and subsequent contamination. However, when used for a long period of time, fine crushed fragments of the toner tend to adhere to the surface of the carrier to cause stains (spent) thereon, with the result that the toner charging capability is lowered to cause problems of fogging and toner scattering. In order to prolong the service life of the two-component developing device, a method for increasing the amount of carrier to be housed in the developing device is proposed; however, this method causes a large-size of the developing device.

In order to solve the above-mentioned problems with the two-component developing device, a tricle developing system in which the carrier or the carrier and the toner are supplied on demand, while the developer having reduction in chargeability is collected, has been proposed (Patent Documents 1 and 2). In accordance with this technique, the service life of the developer can be prolonged, without causing a large size of the developing device. However, a mechanism for recovering the discharged carrier is required. Moreover, the amount of carrier consumption becomes larger to cause resulting problems relating to the cost and the environment. Furthermore, a predetermined amount of printing operations need to be carried out until the ratio between the undeteriorated carrier and the deteriorated carrier has been stabilized.

Citation List

Patent Literature

Patent Document 1: Japanese Patent—Application Laid-Open No. 2005-107377

Patent Document 2: Japanese Patent—Application Laid-Open No. 2001-330985

### SUMMARY OF THE INVENTION

1. Technical Problem

However, the above-mentioned hybrid developing system fails to provide a stable electrostatic property of toner for a long term, in the case when a large amount of prints are made on an image having a small image area ratio (black and white ratio) such as character images. As a result, a problem arises in which the image density is lowered when endurance printing processes are carried out.

The objective of the present invention is to provide a developer for hybrid developing that can electrically charge a toner stably for a long period of time.

2. Solution to Problem

The present invention provide an image-forming method, comprising:

a process in which a toner is supported and transported on the surface of a toner supporting member placed face to face to an electrostatic latent image-supporting member, and electrostatic latent images formed on the electrostatic latent image-supporting member is developed by the toner; and

a process in which a two-component developer containing the toner and a carrier is supported on the surface of a developer-supporting member placed face to face to the toner supporting member and the toner is supplied onto the toner-supporting member,

wherein the developer comprises:

toner particles containing a binder resin and a colorant;

a carrier that charges the toner particles in friction-contact with the toner particles;

reverse polarity particles that are charged to polarity reversed to polarity of the toner particles charged in friction-contact with the carrier; and

homopolarity particles that are charged to the same polarity as polarity of the toner particles charged in friction-contact with the carrier,

wherein the reverse polarity particles have a peak particle size in a range from 0.1 to 0.5 μm in the particle size distribution thereof, the reverse polarity particles have a content in a range from 0.1 to 2 parts by weight relative to 100 parts by weight of the toner particles, the homopolarity particles have a peak particle size in a range from 0.005 to 0.05 μm in the particle distribution thereof, and the homopolarity particles have a content in a range from 0.1 to 2 parts by weight relative to 100 parts by weight of the toner particles.

### ADVANTAGEOUS EFFECTS OF INVENTION

In accordance with the present invention, reverse polarity particles are transferred onto the carrier surface to function as charging sites on the carrier surface. For this reason, it becomes possible to suppress reduction in the toner charging capability of the carrier for a long period of time. In addition, since the homopolarity particles of small particle size behave together with the toner particles so that the flowability of the toner particles on a developing roller is improved, the developing property can be improved. As a result, as excellent electrostatic properties and developing properties of toner can be maintained stably for a long period of time, it is possible to suppress reduction in toner charge amount and reduction in image density even during endurance printing prosesses.

When the developer used in the present invention is applied to a two-component image-forming method, little reverse polarity particles are transferred onto the carrier and the charging sites are not improved on the carrier surface, resulting in such a problem as deterioration in electrostatic property of the carrier surface when used for a long period of term. When the developer used in the present invention is applied to a hybrid developing in combination, the transfer of the reverse polarity particles to carrier is promoted to achieve the above effects.

### BRIEF DESCRIPTION OF DRAWINGS

FIG. 1: A drawing that shows a schematic structure of one example of an image-forming apparatus in accordance with the present invention and a cross section of a developing device in accordance with the present invention.

FIG. 2A: A drawing that shows one embodiment of an electric-field forming device.

FIG. 2B: A drawing that shows a relationship between voltages that are supplied from the electric-field forming device shown in FIG. 2A to the sleeve and the developing sleeve.

FIG. 3A: A drawing that shows another embodiment of an electric-field forming device.

FIG. 3B: A drawing that shows a relationship between voltages that are supplied from the electric-field forming device shown in FIG. 3A to the sleeve and the developing sleeve.

FIG. 4A: A drawing that shows another embodiment of an electric-field forming device.

FIG. 4B: A drawing that shows a relationship between voltages that are supplied from the electric-field forming device shown in FIG. 4A to the sleeve and the developing sleeve.

FIG. 5: A drawing that shows another embodiment of an electric-field forming device.

FIG. 6: A drawing that shows another embodiment of an electric-field forming device.

FIG. 7: A schematic drawing that explains a method for measuring a dynamic current value of a carrier.

### DESCRIPTION OF THE EMBODIMENTS

The present invention relates to a developer for hybrid-developing, comprising:

toner particles containing a binder resin and a colorant;

a carrier that charges the toner particles in friction-contact with the toner particles;

reverse polarity particles that are charged to the reverse polarity to the polarity of the toner particles charged in friction-contact with the carrier; and

homopolarity particles that are charged to the same polarity as the polarity of the toner particles charged in friction-contact with the carrier, in which

the reverse polarity particles have a peak particle size in a range from 0.1 to 0.5 μm in particle-size distribution, a content of the reverse polarity particles is set in the range from 0.1 to 2 parts by weight relative to 100 parts by weight of the toner particles,

the homopolarity particles have a peak particle size in a range from 0.005 to 0.05 μm in particle-size distribution, and a content of the homopolarity particles is set in the range from 0.1 to 2 parts by weight relative to 100 parts by weight of the toner particles.

Developer for Hybrid-Developing

The developer for hybrid-developing (hereinafter, referred to simply as “developer”) of the present invention contains toner particles, an external additive to be externally added to the toner particles and a carrier.

The toner particles, which contain at least a binder resin and a colorant, are charged to a predetermined polarity in friction-contact with the carrier. The toner particles may further contain other external additives, such as a mold release agent and/or a charge-control agent.

Although not particularly limited, examples of the binder resin contained in the toner particles include a styrene-based resin (a monopolymer or a copolymer containing styrene or a styrene substituent; for example, a styrene-acrylic resin), a polyester resin, an epoxy resin, a vinyl chloride resin, a phenolic resin, a polyethylene resin, a polypropylene resin, a polyurethane resin, a silicone resin, a nitrogen-containing acrylic resin, or a mixed resin in which these resins are desirably mixed. The binder resin is preferably set to have a softening temperature in a range from 80 to 160° C. and a glass transition point in a range from about 50 to 75° C.

The binder resin of the toner particles is preferably determined depending on the electrostatic charge polarity of the toner particles upon developing. For example, in the case of negatively chargeable toner particles, a styrene-acrylic copolymer or polyester may be preferably used solely, or these may be mixed with each other. In the case of positively chargeable toner particles, a styrene-acrylic copolymer is preferably used.

Any of commonly known materials conventionally used as colorants in the toner field may be used as the colorant. Specific examples of the colorant include: carbon black, Aniline Black, activated carbon, magnetite, Benzidine Yellow, Permanent Yellow, Naphthol Yellow, Phthalocyanine Blue, Fast Sky Blue, Ultramarine Blue, Rose Bengal and Lake Red. In general, the amount of addition of the colorant is preferably set in a range from 2 to 20 parts by weight relative to 100 parts by weight of the binder resin.

Any of commonly known materials conventionally used as release agents in the toner field may be used as the release agent. Specific examples of the release agent include: polyethylene, polypropylene, carnauba wax and sazol wax, or a mixture in which these are combined with one another on demand. The release agent is preferably used at a rate of 0.1 to 10 parts by weight relative to 100 parts by weight of the binder resin.

Any of commonly known materials conventionally used as charge-control agents in the toner field may be used as the charge-control agent. Specific examples of the positive charge-control agent used for toner particles to be charged to the positive polarity include: a nigrosine dye, a quaternary ammonium salt-based compound, a triphenyl methane-based compound, an imidazole-based compound and a polyamine resin. Specific examples of the negative charge-control agent used for toner particles to be charged to the negative polarity include: an azo-based dye containing metal, such as Cr, Co, Al and Fe, a salicylic acid metal compound, an alkyl salicylic acid metal compound and a calix arene compound. The charge-control agent is preferably used at a rate of 0.1 to 10 parts by weight relative to 100 parts by weight of the binder resin.

Although not particularly limited, examples of the method for manufacturing toner particles include: a so-called pulverizing method and a wet method, such as a suspension polymerization method, an emulsion polymerization association method and a dissolving suspension method. The toner particles made by using the emulsion polymerization association method are preferably used from the viewpoints of providing a sharp grain size distribution of the toner particles, a superior image and a long life of the developer. Although not particularly limited, the volume-average particle size of the toner particles is, for example, set in a range from 3 to 15 μm. The average particle size of the toner particles is obtained based upon values measured by using an aperture tube of 100 μm of a Coulter Multisizer III (made by Beckman Coulter, Inc.).

The following description will explain the method for manufacturing toner particles by the use of the emulsion polymerization association method. The manufacturing method for toner particles in accordance with the emulsion polymerization association method, which relates to a method for forming toner particles in an aqueous medium, is disclosed by, for example, JP-A No. 2002-351142 or the like. The method also includes a method in which resin particles are salted-out/fused in an aqueous medium to produce a toner particle dispersion solution, as disclosed in Japanese Patent-Application Laid-Open No. 5-265252, Japanese Patent-Application Laid-Open No. 6-329947 and Japanese Patent-Application Laid-Open No. 9-15904. More specifically, after resin particles have been dispersed in water by using an emulsifier, a coagulant in a concentration of not less than a critical aggregating concentration is added thereto so as to be salted out, and the resulting polymer thus formed is simultaneously heated and fused at a temperature not less than the glass transition temperature of the polymer itself so that fused particles are formed, while the particles size thereof is gradually grown, and upon achieving the target particle size, a large amount of water is added thereto to stop the growth of the particle size, and the shape of the particles is controlled by smoothing the particle surface, while being heated and stirred, so that a toner particle dispersion solution is prepared. Simultaneously with the addition of the coagulant, a solvent such as alcohol, which is infinitely dissolved in water, may be added thereto. Examples of the aqueous solvent include water, methanol, ethanol, isopropanol, butanol, 2-methyl-2-butanol, acetone, methylethyl ketone, tetrahydrofran, and a mixed solution thereof; however, it is not particularly limited thereby. Upon producing toner particles, a suitable solvent can be selected from these. Another organic solvent may be further added to the aqueous solvent. Although not particularly limited, examples of the organic solvent include toluene, xylene, or a mixed solvent of these.

At least reverse polarity particles and homopolarity particles are used as the external additives to be externally added to the toner particles.

The reverse polarity particles are particles that are charged to the polarity reverse to the polarity of the toner particles charged in friction-contact with the carrier. The fact that the electrostatic charge polarity to the carrier is different between the reverse polarity particles and the toner particles can be found by measuring the quantities of charge thereof to the carrier. For example, a carrier and the reverse polarity particles are subjected to a predetermined mixing process, and a quantity of charge of the reverse polarity particles is measured by using a blow-off method. On the other hand, the carrier and the toner particles are also subjected to a predetermined mixing process, and a quantity of charge of the toner particles is measured by the blow-off method. As a result, when the quantity of charge of the reverse polarity particles and that of the toner particles have mutually different signs, it is confirmed that the electrostatic charge polarities of those particles to the carrier are different from each other.

The quantity of charge by the use of the blow-off method is measured by a charge-quantity measuring device “Blow-off type TB-200” (manufactured with Toshiba Corporation).

The peak particle size in the particle size distribution of the reverse polarity particles is set to 0.1 to 0.5 μm, and from the viewpoint of long-term stability of the toner charging by the carrier, it is preferably set to 0.2 to 0.4 μm. When the peak particle size is too small, the reverse polarity particles are embedded into the toner particles to be prevented from being transferred to the carrier surface, with the result that since it is not possible to suppress reduction in the toner charging capability of the carrier, the image density is lowered upon carrying out endurance printing processes. When the peak particle size is too large, the reverse polarity particles are hardly adhered to the carrier surface effectively, with the result that the image density is lowered upon carrying out endurance printing processes.

In the present specification, the particle-size distribution refers to volume particle-size distribution, and the peak particle size can be obtained from the particle-size distribution measured by a dynamic light-scattering method.

In the particle-size distribution of the reverse polarity particles, the rate of content of the particles having a particle size of less than 0.05 μm is preferably set to 3 volume % or less, in particular, to 1 volume % or less, from the viewpoint of suppressing reduction in the density upon carrying out endurance printing processes. The rate of content of the particles having a particle size exceeding 1 μm is preferably set to 10 volume % or less, in particular, to 3 volume % or less from the viewpoint of suppressing reduction in the density upon carrying out endurance printing processes.

For example, in the case when toner particles to be negatively charged in friction-contact with the carrier are used, those particles that are positively charged in friction-contact with the carrier are used as the reverse polarity particles. Examples of such particles include inorganic particles of strontium titanate, barium titanate, magnesium titanate, calcium titanate and alumina, or particles made from a thermoplastic resin or a thermosetting resin, such as an acrylic resin, a benzoguanamine resin, a nylon resin, a polyimide resin and a polyamide resin. Particles, made by allowing a resin forming the reverse polarity particles to contain a positive charge control agent that is positively charged in contact with the carrier, may be used as well. For example, a nigrosine dye, a quaternary ammonium salt may be used as the positive charge control agent. The reverse polarity particles may be formed of a nitrogen-containing polymer. Examples of the material forming the nitrogen-containing polymer include: 2-dimethylaminoethyl acrylic acid, 2-diethylaminoethyl acrylic acid, 2-dimethylaminoethyl methacrylic acid, 2-diethylaminoethyl methacrylic acid, vinyl pyridine, N-vinyl carbazole and vinyl imidazole. The preferable combinations between a resin forming the carrier and a material forming reverse polarity particles (positively chargeable) are shown below:

Carrier Forming Resin-Reverse Polarity Particles (Positively Chargeable)

Polymethylmethacrylate resin-Strontium titanate

Silicone resin-Barium titanate

Melamine resin-Calcium zirconate

Benzoguanamine resin-Magnesium zirconate

For example, in the case when toner particles that are positively charged in friction-contact with the carrier are used, those particles that are negatively charged in friction-contact with the carrier are used as the reverse polarity particles. For example, particles made of inorganic particles such as silica, titanium oxide and aluminum oxide, or particles made from a thermoplastic resin or a thermosetting resin, such as a fluorine resin, a polyolefin resin, a silicone resin and a polyester resin, may be used as those particles. Particles, made by allowing a negative charge control agent that is negatively charged in contact with the carrier to be contained in a resin forming the reverse polarity particles, may also be used. Examples of the negative charge control agent include: a salicylic acid-based or naphthol-based chromium complex, an aluminum complex, an iron complex, a zinc complex and the like. Copolymer particles of a fluorine-containing acrylic monomer and a fluorine methacrylic monomer may be used as the reverse polarity particles. The preferable combinations between the resin forming the carrier and the material forming the reverse polarity particles (negatively chargeable) are shown below:

Carrier-Reverse Polarity Particles (Negatively Chargeable)

Fluorine resin-Silica

Polyester-Aluminum oxide

Polyolefin-Polyacrylic fluoride beads

In order to control the electrostatic property and hydrophobicity of the reverse polarity particles, the surface of the inorganic particles may be surface-treated by using a silane coupling agent, a titanium coupling agent, silicone oil or the like. In particular, upon imparting the electrostatic property of positive polarity to the inorganic particles, it is preferable to carry out the surface treatment by using an amino-group containing coupling agent. Upon imparting the electrostatic property of negative polarity to the particles, it is preferable to carry out the surface treatment by using a fluorine-group containing coupling agent.

The content of the reverse polarity particles is set to 0.1 to 2 parts by weight relative to 100 parts by weight of the toner particles, and from the viewpoint of a long-term stability of the toner charge, it is preferably set to 0.3 to 1.9 parts by weight. In the case when the content is too small, even if the reverse polarity particles are transferred onto the carrier surface to adhere thereto, the charging sites fail to function effectively to cause reduction in the image density upon carrying out endurance printing processes. When the content is too large, the quantity of charge of the toner is lowered to cause reduction in the image density upon carrying out endurance printing processes. Two or more kinds of reverse polarity particles may be used in combination, and in this case, the total amount of these is set within the above-mentioned range.

The homopolarity particles are particles that are charged to the same polarity as the polarity of the toner particles charged in friction-contact with the carrier. The fact that the electrostatic charge polarity to the carrier is the same between the homopolarity particles and the toner particles can be found by measuring the quantities of charge thereof to the carrier. For example, a carrier and the homopolarity particles are subjected to a predetermined mixing process, and a quantity of charge of the homopolarity particles is measured by using a blow-off method. On the other hand, the carrier and the toner particles are also subjected to a predetermined mixing process, and a quantity of charge of the toner particles is measured by using the blow-off method. As a result, when the quantity of charge of the homopolarity particles and the quantity of charge of the toner particles have the same sign, it is confirmed that the charging polarities of those particles relative to the carrier are the same.

Preferable homopolarity particles are those particles that are charged to the same polarity as the electrostatic charge polarity of the toner particles relative to the carrier even in friction-contact with the toner particles. As a result, the electrostatic property and flowability of the toner are stabilized, thereby making it possible to suppress reduction in image density upon carrying out endurance printing processes.

The electrostatic charge polarity of the homopolarity particles due to frictional contact with the toner particles can be indirectly found by measuring the quantity of charge of the toner particles due to frictional contact with the carrier and the quantity of charge of the homopolarity particles due to frictional contact with the carrier. For example, the carrier and the toner particles are subjected to a predetermined mixing process, and the quantity of charge of the toner particles is measured by the blow-off method. The carrier and the homopolarity particles are also subjected to a predetermined mixing process, and a quantity of charge of the homopolarity particles is measured by using the blow-off method. At this time, with respect to the measured samples, the content of the homopolarity particles relative to the carrier is set to the same as the content of the toner particles relative to the carrier, and the mixing conditions and the charge quantity measuring conditions are set to the same. Consequently, the quantities of charge of the toner particles and the homopolarity particles have the same sign (positive or negative); therefore, in the case when the absolute value of the quantity of charge of the homopolarity particles is greater than the absolute value of the quantity of charge of the toner particles, the corresponding homopolarity particles are found to be charged to the same polarity as the electrostatic charge polarity of the toner particles relative to the carrier, when in contact with the toner particles.

The peak particle size in the particle size distribution of the homopolarity particles is set to 0.005 to 0.05 μm, and from the viewpoint of flowability of the toner, it is preferably set to 0.006 to 0.04 μm. When the peak particle size is too small, the homopolarity particles are embedded into the toner particles to cause reduction in the electrostatic property and flowability, with the result that the image density is lowered upon carrying out endurance printing processes. When the peak particle size is too large, the homopolarity particles tend to come off the toner particles to cause reduction in the electrostatic property and flowability, with the result that the image density is lowered upon carrying out endurance printing processes.

For example, in the case of using toner particles to be negatively charged in friction-contact with the carrier, those particles that are negatively charged in friction-contact with the carrier are used as the homopolarity particles. With respect to such homopolarity particles, in the case of using particles to be negatively charged when made in friction-contact with the carrier as the reverse polarity particles, those particles, made from the same material as that of the reverse polarity particles, may be used. The preferable combinations of a material forming the reverse polarity particles (positively chargeable) and a material forming homopolarity particles (negatively chargeable) are shown below:

Reverse Polarity Particles (Positively Chargeable-Homopolarity Particles (Negatively Chargeable)

Strontium titanate-Silica

Barium titanate-Titanium oxide

Calcium zirconate-Aluminum oxide

Magnesium zirconate-Polyacrylic fluoride beads

Examples of silica particles to be used as the homopolarity particles include: commercial products, R-805, R-976, R-974, R-972, R-812 and R-809, made by Nippon Aerosil Co., Ltd.; HVK-2150 and H-200, made by Hoechst Limited.; and commercial products, TS-720, TS-530, TS-610, H-5 and MS-5, made by Cabot Japan K.K. Specific examples of titanium oxide particles include: commercial products, T-805 and T-604, made by Nippon Aerosil Co., Ltd.; commercial products, MT-100S, MT-100B, MT-500BS, MT-600, MT-600SS and JA-1, made by Tayca Corporation; commercial products, TA-300SI, TA-500, TAF-130, TAF-510, TAF-510T, made by Fuji Titanium Industry Co., Ltd.; and commercial products, IT-S, IT-OA, IT-OB, IT-OC and the like, made by Idemitsu Kosan Co., Ltd. With respect to the aluminum oxide particles, examples thereof include: commercial products RFY-C and C-604, made by Nippon Aerosil Co., Ltd., and commercial products, TTO-55 made by Ishihara Sangyo Kaisha, Ltd.

For example, in the case of using toner particles to be positively charged in friction-contact with the carrier, those particles that are positively charged in friction-contact with the carrier are used as the homopolarity particles. With respect to such homopolarity particles, in the case of using particles to be positively charged when made in friction-contact with the carrier as the reverse polarity particles, those particles, made from the same material as that of the reverse polarity particles, may be used as such homopolarity particles. The preferable combinations of a material forming the reverse polarity particles (negatively chargeable) and a material forming homopolarity particles (positively chargeable) are shown below:

Reverse Polarity Particles (Negatively Chargeable-Homopolarity Particles (Positively Chargeable))

Silica-Strontium titanate

Titanium oxide-Barium titanate

Aluminum oxide-Calcium zirconate

Polyacrylic fluoride beads-Magnesium zirconate

In order to control the electrostatic property and hydrophobicity of the homopolarity particles, in the same manner as in the reverse polarity particles, the surface of the inorganic particles may be surface-treated by using a silane coupling agent, a titanium coupling agent, silicone oil or the like. The surface treating agent may be selected in the same manner as in the surface treatment of the reverse polarity particles.

The content of the homopolarity particles is set to 0.1 to 2 parts by weight relative to 100 parts by weight of the toner particles, and from the viewpoint of a long-term stability of the toner charge, it is preferably set to 0.3 to 1.9 parts by weight. In the case when the content is too small, the electrostatic property of toner is lowered to cause reduction in the image density upon carrying out endurance printing processes. When the content is too large, the electrostatic property of toner is lowered to cause reduction in the image density upon carrying out endurance printing processes. Two or more kinds of homopolarity particles may be used in combination, and in this case, the total amount of these is set within the above-mentioned range.

From the viewpoint of the electrostatic property of the toner, the content of the homopolarity particles is preferably set to 0.5 to 20 times, in particular, to 1.0 to 10 times the content of the reverse polarity particles at a weight ratio thereto.

A toner to be used in the present invention can be obtained by mixing external additives, such as at least reverse polarity particles and homopolarity particles, with toner particles. With respect to the order of addition of the reverse polarity particles and the homopolarity particles, not particularly limited, for example, these may be simultaneously added and mixed with each other, or after preliminarily adding the homopolarity particles to be mixed therewith, the reverse polarity particles may be added and mixed therewith, or these may be added and mixed therewith in the order reversed to this. From the viewpoint of the transferring property of the reverse polarity particles to the carrier, the reverse polarity particles are preferably added and mixed therewith, after the homopolarity particles have been preliminarily added and mixed therewith. As the mixing device, any one of various known mixing devices, such as a tabular mixer, a Henschel mixer, a Nauta mixer and a V-type mixer, may be used.

External additives other than the reverse polarity particles and the homopolarity particles may be added to the toner. Those additives conventionally used as external additives in the field of toner may be used as such other external additives.

Those carriers conventionally used as carriers in the field of two-component developers may be used as the carrier contained in the developer of the present invention, and examples thereof include a carrier that uses magnetic particles as they are, a coat-type carrier formed by coating magnetic particles with resin and a binder-type carrier formed by dispersing magnetic particles in a resin. As the magnetic material to be used for the carrier, for example, iron powder, magnetite and various ferrites may be used, and preferably, magnetite and various ferrites are used. Examples of the ferrite include ferrites containing a heavy metal, such as copper, zinc, nickel and manganese, and ferrites containing a light metal, such as an alkali metal and/or alkali-earth metal, and in particular, a light-metal ferrite containing an alkali metal and/or an alkali-earth metal is more preferably used.

From the viewpoint of charging property, the coat-type carrier is preferably used as the carrier. The magnetic particles (carrier core) of desirable coat-type carrier is a light metal ferrite containing an alkali metal such as Li and Na and/or an alkali—earth metal such as Mg, Ca, Sr and Ba, or magnetite. Specific examples of such light metal ferrites include those having composition (1) or (2) shown below.

(M¹₂O)ₓ(Fe₂O₃)₁₋ₓ (1)

(M²O)ₓ(F₂O₃)₁₋ₓ (2)

In the compositions (1) and (2), M¹ represents an alkali metal such as Li and Na. M² represents an alkali-earth metal such as Mg, Ca, Sr and Ba. Here, x represents 30 mol % or less, preferably 18 mol % or less.

The light metal ferrite of the above-mentioned composition (1) may be a material formed by substituting one portion of M¹₂O and/or Fe₂O₃ with an alkali-earth metal oxide (M²O). The alkali-earth metal oxide to be substituted is preferably set in a range from 1 to 10 mol %. More preferably, it is set in a range from 3 to 15 mol %.

The reason that the above-mentioned light metal ferrite or magnetite is preferably used is because, in addition to simply solving recently raised problems of wastes and environmental pollution, they have advantages that it is possible to make the carrier itself lighter, and also to reduce stress to be applied to the toner.

The volume-average particle size of the magnetic particles of the coat-type carrier is set to 10 to 100 μm, preferably 20 to 80 μm. Moreover, the carrier preferably has a magnetizing property in a range from 30 to 60 μm²/kg in saturated magnetization as its own magnetizing property. The volume-average particle size of the magnetic particles is an average particle size on the volume basis measured by a laser diffraction-type grain distribution measuring device “HELOS” equipped with a wet disperser (manufactured with Sympatec Co., Ltd.). The saturated magnetization is measured by using a “DC magnetization property automatic recording device 3257-35” (manufactured with Yokogawa Electric Corp.).

Examples of preferable resins used for forming a coat layer of the coat-type carrier include: polyolefin-based resins, such as polyethylene, polypropylene, chlorinated polyethylene, and chlorosulfonated polyethylene; polyvinyl and polyvinylidene-based resins, such as polyacrylates like polystyrene and polymethylmethacrylate, polyacrylonitrile, polyvinyl acetate, polyvinyl alcohol, polyvinyl butyral, polyvinyl chloride, polyvinyl carbazole, polyvinyl ether, polyvinyl ketone; copolymers, such as a vinylchloride-vinylacetate copolymer and a styrene-acrylate copolymer; a silicone resin made of an organo-siloxane bond or its modified resin (for example, modified resins derived from an alkyd resin, a polyester resin, an epoxy resin and polyurethane); fluorine resins, such as polyvinyl fluoride, polyvinylidene fluoride, and polychlorotrifluoroethylene; polyamide; polyester; polyurethane; polycarbonate; amino resin such as urea-formaldehyde resin; and epoxy resins. In the present invention, from the viewpoints of electrostatic property control of the developer and the durability of the coat layer, polyacrylates, such as polystyrene and polymethylmethacylate, are more preferably used.

The method for forming a coat layer includes a wet coating method and a dry coating method. The following description will discuss each of the methods in detail.

Specific examples of the wet coating method include a fluidized bed-type spray coating method, an immersion-type coating method and a polymerization method. In the fluidized bed-type spray coating method, a coating solution, prepared by dissolving a coating resin in a solvent, is spray-coated onto the surface of magnetic particles by using a fluidized bed, and then dried to form a coat layer. In the immersion-type coating method, magnetic particles are immersed in a coating solution prepared by dissolving a coating resin in a solvent so as to be subjected to a coating treatment, and then dried to form a coat-layer. In the polymerization method, magnetic particles are immersed in a coating solution prepared by dissolving a reactive compound in a solvent so as to be subjected to a coating treatment, and then heated to carry out a polymerizing reaction thereon so that a coat-layer is formed.

In the dry coating method, resin particles are adhered to the surface of a particle (magnetic particle) to be coated, and then subjected to a mechanical impact force so that the resin particles adhered to the particle surface to be coated are fused or softened to be anchored thereon so that a coat layer is formed. For example, a core material (magnetic particle), a resin, charge-control particles and low-resistance fine particles are high-speed stirred by using a high-speed stirring mixer in which a mechanical impact force can be applied under a non-heating state or under a heating state so that the mixture is subjected to an impact force repeatedly; thus, a carrier on which resin is fused or softened to be anchored on the surface of each of magnetic particles so that a carrier is produced. In the case of heating, the heating temperature is preferably set in a range from 60 to 125° C. Since aggregation tends to occur among the carrier particles when the heating temperature is too high.

The average particle size of the carrier to be used in the present invention is preferably set to 10 to 150 μm, in particular to 20 to 100 μm. The average particle size of the carrier is a value measured by using the aforementioned laser diffraction-type grain distribution measuring device “HELOS” (manufactured with Sympatec Co., Ltd.).

The dynamic current value of the carrier is preferably set to 0.05 to 0.6 μA, in particular, to 0.1 to 0.5 μA. When the electric current value is too small, the toner supplying property from the sleeve to the developing roller is lowered. When the electric current value is too large, the toner recovering property from the developing roller to the sleeve is lowered.

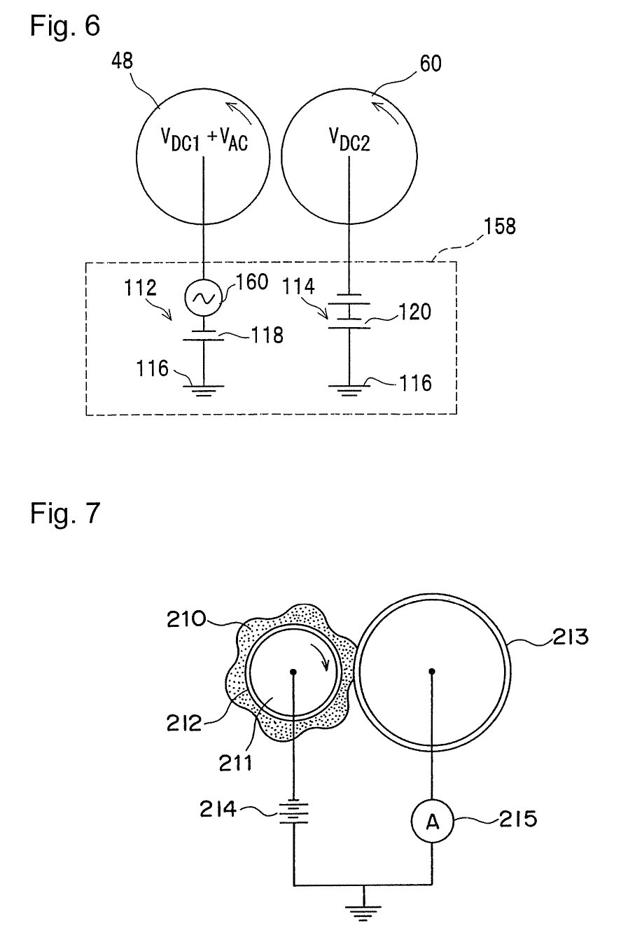

In the present specification, values measured by the following method using a device having a structure schematically shown in FIG. 7 are used as the dynamic current value (CDC value) for the carrier.

A carrier (210) is set in an aluminum sleeve (212), and a voltage is applied thereto by a DC power supply (214), while the sleeve (212) is being rotated. A current flowing through an ampere meter (215) from the sleeve (212) via the carrier (210) and an aluminum pipe (213) is measured. The measuring conductions are shown below:

Number of revolutions of sleeve: 50 rpm.

Applied voltage: 500 V

Amount of sample: 5 g

Sleeve (212)

Length in longitudinal direction: 55 mm, diameter: 31 mm, magnetic force of magnet: 1000 Gauss, number of magnet poles: 8

Aluminum pipe (213)

Length in longitudinal direction: 55 mm, diameter: 30 mm

The mixing ratio of the carrier and the toner is desirably adjusted so as to obtain a desired quantity of toner charge, and the toner mixing ratio is preferably set to 3 to 50% by weight, preferably to 6 to 30% by weight, relative to the total quantity of the toner and the carrier.

Image-Forming Apparatus

The developer of the present invention is used for a hybrid developing device and an image-forming apparatus provided with such a developing device. The hybrid developing system is a system in which a two-component developer, held on an outer circumferential face of a first transporting member (transporting roller), is transported to an area opposing to a second transporting member (developing roller), and a toner is selectively supplied onto the outer circumferential face of the second transporting member so that a toner thin layer is formed on the outer circumferential face of the second transporting member and an electrostatic latent image on the electrostatic-latent-image supporting member is subsequently developed by using the toner thin layer.

Referring to attached drawings, the following description will explain preferable embodiments of the present invention. In the following explanation, terms indicating specific directions (for example, “up”, “down”, “left” and “right” and other terms including these, as well as “clockwise direction” and “anticlockwise direction”) are used; however, these terms are used only for easiness of understanding of the present invention by reference to drawings, and the present invention is not intended to be interpreted in a limited manner by the meanings of these terms. In the image forming apparatus and the developing device explained below, the same or similar components are indicated by the same reference numerals.

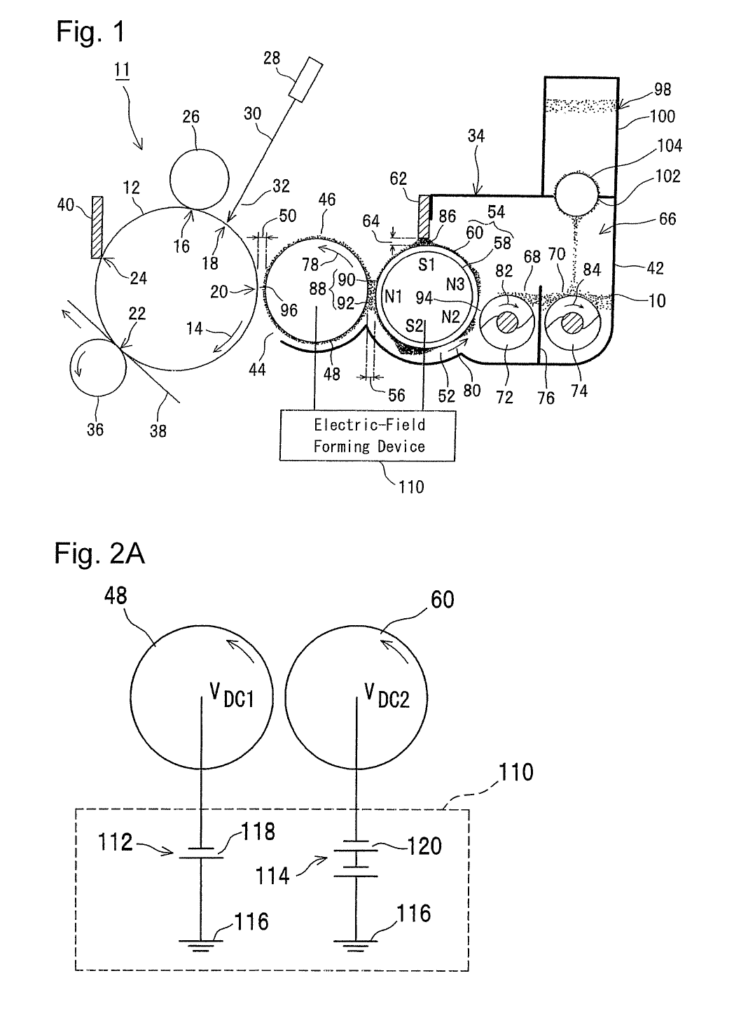

FIG. 1 shows one example of components related to image-forming processes of an electrophotographic image-forming apparatus in accordance with the present invention. The image-forming apparatus may be any one of a copying machine, a printer, a facsimile and a composite machine provided with these functions in a composite manner. This image-forming apparatus 11 is provided with a photosensitive member 12 serving as an electrostatic latent-image supporting member. In this embodiment, the photosensitive member 12 is made of a cylindrical member; however, the present invention is not intended to be limited by this mode, and instead of this, a photosensitive member of an endless belt type may also be used. The photosensitive member 12 is connected to a motor, not shown, to be driven thereby, and allowed to rotate in a direction indicated by arrow 14 when driven by the motor. On the periphery of the photosensitive member 12, a charging station 16, an exposing station 18, a developing station 20, a transferring station 22 and a cleaning station 24 are disposed, along the rotation direction of the photosensitive member 12.

The charging station 16 is provided with a charging device 26 that charges a photosensitive layer forming the outer circumferential face of the photosensitive member 12 to a predetermined electric potential. In the present embodiment, the charging device 26 is shown as a roller having a cylindrical shape; however, instead of this, a charging device of another mode (for example, a brush-type charging device of a rotation type or a fixed type, or a wire discharging-type charging device) may be used. The exposing station 18 is provided with a passage 32 that allows imaging light 30, emitted from an exposing device 28 placed near the photosensitive member 12 or at a position apart from the photosensitive member 12, to proceed toward the outer circumferential face of the charged photosensitive member 12. On the outer circumferential face of the photosensitive member 12 that has passed through the exposing station 18, an electrostatic latent image, formed of portions where the electric potential has been damped by the imaging light projected thereto and portions where the charged electric potential has been virtually maintained, is formed. In the present embodiment, the portions having the damped electric potential correspond to an electrostatic latent image portion, and the portions that virtually maintain the charged electric potential correspond to an electrostatic latent image non-image portion. The developing station 20 has a developing device 34 that visualizes the electrostatic latent image by using a powder developer. The developing device 34 will be explained later in detail. The transferring station 22 is provided with a transferring device 36 that transfers the visible image formed on the outer circumferential face of the photosensitive member 12 onto a sheet 38 such as paper and a film. In the present embodiment, the transferring member 36 is shown as a roller having a cylindrical shape; however, a transferring device of another mode (for example, wire charging-type transferring device) may be used. The cleaning station 24 is provided with a cleaning device 40 that collects untransferred toner remaining on the outer circumferential face of the photosensitive member 12, without having been transferred onto the sheet 38 in the transferring station 22, from the outer circumferential face of the photosensitive member 12. In the present embodiment, the cleaning device 40 is shown as a plate-shaped blade; however, instead of this, a cleaning device of another mode (for example, a rotation-type or fixed brush-type cleaning device) may be used.

Upon forming an image by using the image-forming device 11 with this structure, the photosensitive member 12 rotates clockwise by the driving operation of the motor (not shown). At this time, the outer circumferential portion of the photosensitive member that has passed through the charging station 16 is charged by the charging device 26 to a predetermined electric potential. The charged outer circumferential portion of the photosensitive member is exposed by the imaging light 30 in the exposing station 18 so that an electrostatic latent image is formed. The electrostatic latent image is transported to the developing station 20 together with the rotation of the photosensitive member 12, and visualized therein by the developing device 34 as a developer image. The developer image thus visualized is transported to the transferring station 22 together with the rotation of the photosensitive member 12, and then transferred onto a sheet 38 by the transferring device 36. The sheet 38 on which the developer image has been transferred, is transported to a fixing station, not shown, where the developer image is fixed onto the sheet 38. The outer circumferential portion of the photosensitive member that has passed through the transferring station 22 is then transported to the cleaning station 24 where the developer that remains on the outer circumferential face of the photosensitive member 12 without being transferred onto the sheet 38 is collected.

Developing Device

The developing device 34 is provided with a developer container (housing) 42 that houses a developer 10 of the present invention and various members, which will be explained below. For easiness of understanding of the present invention, one portion of the developer container 42 is omitted so as to simplify the drawings. The developer container 42 is provided with a series of openings (44, 52) that are opened toward the photosensitive member 12, and a developing roller 48 serving as a toner transporting member (second transporting member) is placed in a space 46 formed near the opening 44. This developing roller 48, which is a cylindrical member (second rotation cylindrical member), is rotatably placed in parallel with the photosensitive member 12, with a predetermined developing gap 50 interposed relative to the outer circumferential face of the photosensitive member 12.

Another space 52 serving as an opening portion is formed behind the developing roller 48. In this space 52, a transporting roller 54 serving as a developer transporting member (first transporting member) is disposed in parallel with the developing roller 48, with a predetermined supply/recovery gap 56 being interposed between it and the outer circumferential face of the developing roller 48. The transporting roller 54 is provided with a magnet member 58 secured thereto so as not to rotate, and a cylindrical sleeve 60 (first rotation cylindrical member) supported so as to rotate on the periphery of the magnet member 58. Above the sleeve 60, a regulating plate 62, which is secured to the developer container 42, and extends in parallel with the center axis of the sleeve 60, is placed face to face therewith, with a predetermined regulating gap 64 interposed therebetween.

The magnet member 58 has a plurality of magnetic poles that are aligned face to face with the inner face of the transporting roller 54, and extended in the center axis direction of the transporting roller 54. In the present embodiment, the magnetic poles include a magnetic pole S1 that faces the upper inner circumferential portion of the transporting roller 54 located near the regulating plate 62, a magnetic pole N1 that faces the inner circumferential face on the left side of the transporting roller 54 located near the supply/recover gap 56, a magnetic pole S2 that faces the lower inner circumferential face of the transporting roller 54, and two adjacent magnetic poles N2 and N3 having the same polarity that face the inner circumferential face on the right side of the transporting roller 54.

A developer stirring chamber 66 is formed behind the transporting roller 54. The stirring chamber 66 is provided with a front chamber 68 formed near the transporting roller 54 and a rear chamber 70 apart from the transporting roller 54. A front screw 72, which serves as a front stirring transport member that transports the developer from the surface of the Figure toward the rear face thereof, while stirring the developer, is placed in the front chamber 68 so as to rotate therein, and a rear screw 74, which serves as a rear stirring transport member that transports the developer from the rear face of the Figure toward the surface thereof, while stirring the developer, is placed in the rear chamber 70 so as to rotate therein. As shown in the Figure, the front chamber 68 and the rear chamber 70 may be separated by a partition wall 76 placed between the two chambers. In this case, a partition wall portion located near the two ends of the front chamber 68 and the rear chamber 70 is removed to form a communication passage so that the developer that has reached the end portion on the downstream side of the front chamber 68 is sent to the rear chamber 70 through the communication passage, while the developer that has reached the end portion on the downstream side of the rear chamber 70 is sent to the front chamber 68 through the communication passage.

The following description will explain operations of the developing device 34 having this structure. Upon forming an image, the developing roller 48 and the sleeve 60, driven by motors not shown, are allowed to rotate respectively in directions of arrows 78 and 80. The front screw 72 rotates in a direction of arrow 82, while the rear screw 74 rotates in a direction of arrow 84. Consequently, the developer 10, housed in the developer stirring chamber 66, is stirred, while being transported and circulated between the front chamber 68 and the rear chamber 70. As a result, the toner (toner particles) and carrier contained in the developer are made friction-contact with each other to be charged to respectively reversed polarities.

The developer 10, thus charged, is supplied to the transporting roller 54, while being transported through the front chamber 68 by the front screw 72. The developer 10, supplied onto the transporting roller 54 from the screw 72, is held onto the outer circumferential face of the sleeve 60 near the magnetic pole N3 by the magnetic force of the magnetic pole N3. The developer 10, held on the sleeve 60, forms a magnetic brush along lines of magnetic forces formed by the magnet member 58, and is transported anticlockwise due to the rotation of the sleeve 60. The developer 10, held by the magnetic pole S1 on an opposing area (regulating area 86) to the regulating plate 62, is regulated by the regulating plate 62 so that the amount thereof to be allowed to pass through the regulating gap 64 is regulated to a predetermined amount. The developer 10 that has passed through the regulating gap 64 is transported to an area (supply/recover area) 88 opposing to the magnetic pole N1, where the developing roller 48 and the transporting roller 54 are made face to face with each other. Mainly at an area (supply area) 90 on the upstream side of the supply/recovery area 88 relative to the rotation direction of the sleeve 60, the toner (toner particles) adhering to the carrier is electrically supplied to the developing roller 48 due to the presence of an electric field formed between the developing roller 48 and the sleeve 60. Mainly at an area (recovery area) 92 on the down stream side of the supply/recovery area 88 relative to the rotation direction of the sleeve 60, toner (toner particles) on the developing roller 48 that has not been consumed by the developing and has been returned to the supply/recovery area 88 is scraped by the magnetic brush formed along the lines of magnetic forces of the magnetic pole N1, and recovered by the sleeve 60. The carrier is held on the outer circumferential face of the sleeve 60 by a magnetic force of the magnet member 58 so that it is not allowed to move from the sleeve 60 to the developing roller 48. In the present invention, the reverse polarity particles are allowed to behave together with the carrier, thereby making it possible to suppress reduction in the toner chargeability by the carrier.

The developer 10, which has passed through the supply/recovery area 88, is held by the magnetic force of the magnet member 58 so that, when having reached the opposing area (releasing area 94) between the magnetic poles N2 and N3 after having passed through the opposing portion to the magnetic pole S2 along with the rotation of the sleeve 60, the developer 10 is released from the outer circumferential face of the sleeve 60 toward the front chamber 68 by a repulsive magnetic field formed by the magnetic poles S2 and S3, and mixed with the developer 10 that is being transported in the front chamber 68.

The toner (toner particles), held by the developing roller 48 at the supply area 90, is transported anticlockwise along with the rotation of the developing roller 48 so that, at an area (developing area) 96 where the photosensitive member 12 and the developing roller 48 are made face to face with each other, the toner is allowed to adhere to an electrostatic latent image portion formed on the outer circumferential face of the photosensitive member 12. In an image-forming apparatus of the present embodiment, a predetermined electric potential V_{H} of negative polarity is applied to the outer circumferential face of the photosensitive member 12 by the charging device 26, and the electrostatic latent image portion to which imaging light 30 has been projected by the exposing device 28 is damped to a predetermined electric potential V_{L} so that the electrostatic latent image non-image portion to which no imaging light 30 has been projected by the exposing device 28 is allowed to maintain virtually the charged electric potential V_{H}. Therefore, in the developing area 96, the toner charged to the negative polarity is allowed to adhere to the electrostatic latent image portion by a function of an electric field formed between the photosensitive member 12 and the developing roller 48 so that this electrostatic latent image is visualized as a developer image. The amount of toner to be held as a thin layer on the surface of the developing roller 48 and transported to the developing area is preferably set in a range from 3 to 10 g/m².

When the toner (toner particles) has been consumed from the developer 10 in this manner, it is preferable to supply toner at an amount corresponding to the consumed amount to the developer 10. For this reason, the developing device 34 is provided with a means used for measuring a mixed ratio between the toner and the carrier housed in the developer container 42. A toner supplying unit 98 is placed above the rear chamber 70. The toner supplying unit 98 has a holder 100 used for housing the toner. An opening portion 102 is formed on the bottom portion of the holder 100, and a supplying roller 104 is placed in this opening portion 102. The supplying roller 104 is connected to a motor, not shown, so as to be driven, and the motor is driven based upon an output of the means for measuring the mixed ratio of the toner and carrier so that the toner is allowed to drop and supplied to the rear chamber 70. In the present invention, since the developer, in particular, reverse polarity particles, is improved in its flowability by the homopolarity particles, and allowed to behave together with the carrier so that the consumption of the reverse polarity particles can be suppressed.

Electric-Field Forming Means

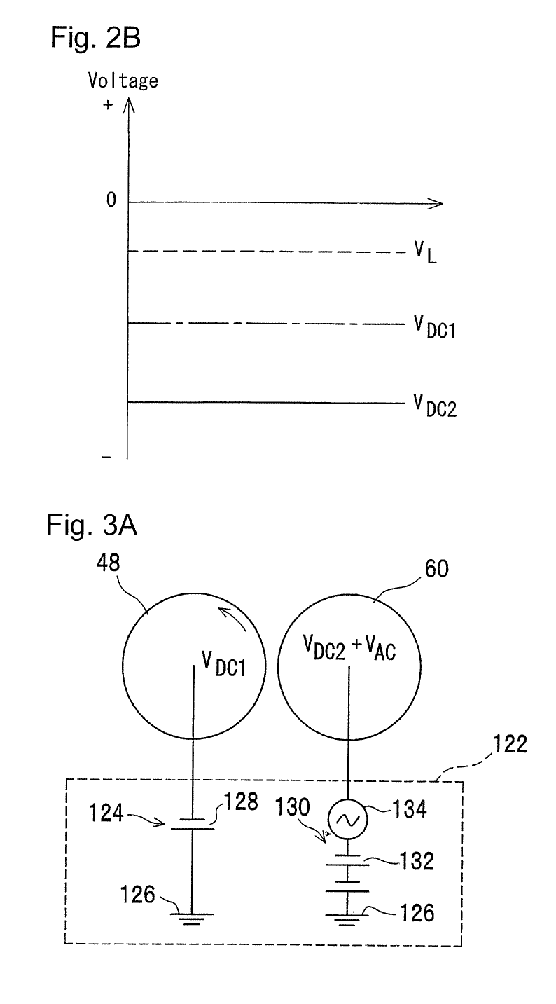

In order to efficiently transfer the toner from the sleeve 60 to the developing roller 48 in the supply area 90, the developing roller 48 and the sleeve 60 are electrically connected to an electric-field forming device 110. Specific examples of power supplies are shown in FIGS. 2A to 6.

An electric-field forming device 110 of embodiment 1 shown in FIG. 2A is provided with a first power supply 112 (corresponding to a second electric-field forming means) connected to the developing roller 48 and a second power supply 114 (corresponding to a first electric-field forming means) connected to the sleeve 60. The first power supply 112 has a DC power supply 118 connected between the developing roller 48 and the ground 116 so that a first DC voltage V_{DC1} (for example, −200 volts) having the same polarity as the electrostatic charge polarity of the toner is applied to the developing roller 48. The second power supply 114 is provided with a DC power supply 120 connected between the sleeve 60 and the ground 116 so that a second DC voltage V_{DC2} (for example, −400 volts) having the same polarity as the electrostatic charge polarity of the toner and a higher voltage than the first DC voltage is applied to the sleeve 60. As a result, in the supply area 90, the toner, charged into the negative polarity by the function of a DC electric field formed between the developing roller 48 and the sleeve 60, is electrically attracted from the sleeve 60 onto the developing roller 48. At this time, the carrier, charged into the positive polarity, is not attracted from the sleeve 60 onto the developing roller 48. In the developing area 96, the negative polarity toner, held on the developing roller 48, is allowed to adhere to the electrostatic latent image portion based upon the electric potential difference between the developing roller 48 (V_{DC1}: −200 volts) and the electrostatic latent image portion (V_{L}: −80 volts), as shown in FIG. 2B. At this time, the negative polarity toner is not adhered to the electrostatic latent image portion due to the electric potential difference between the developing roller 48 (V_{DC1}: −200 volts) and the electrostatic latent image portion (V_{H}: −600 volts)

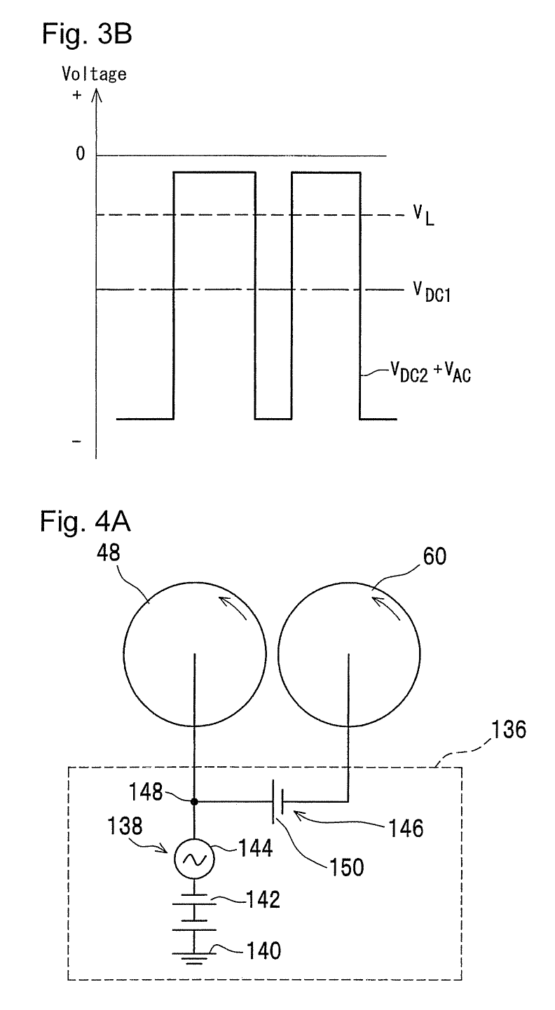

In an electric-field forming device 122 shown in FIG. 3A relating to embodiment 2, a first power supply 124 (corresponding to a second electric-field forming means) is provided with a DC power supply 128 connected between the developing roller 48 and the ground 126 in the same manner as in the power supply of embodiment 1 so that a first DC voltage V_{DC1} (for example, −200 volts) having the same polarity as the electrostatic charge polarity of the toner is applied to the developing roller 48. A second power supply 130 (corresponding to a first electric-field forming means) is provided with a DC power supply 132 and an AC power supply 134 connected between the sleeve 60 and the ground 126. The DC power supply 132 applies a second DC voltage V_{DC2} (for example, −400 volts) having the same polarity as the electrostatic charge polarity of the toner and a higher voltage than the first DC voltage is applied to the sleeve 60. As shown in FIG. 3B, the AC power supply 134 applies an AC voltage V_{AC} having a peak-to-peak voltage V_{P-P} of, for example, 300 volts between the sleeve 60 and the ground 126. As a result, in the supply area 90, the toner, charged into the negative polarity by the function of a pulsating current electric field formed between the developing roller 48 and the sleeve 60, is electrically attracted from the sleeve 60 to the developing roller 48. At this time, the carrier, charged into the positive polarity, is held onto the sleeve 60 by a magnetic force of the fixed magnet inside the sleeve 60, and is not supplied to the developing roller 48. In the developing area 96, the negative polarity toner, held on the developing roller 48, is allowed to adhere to the electrostatic latent image portion based upon the electric potential difference between the developing roller 48 (V_{DC1}: −200 volts) and the electrostatic latent image portion (V_{L}: −80 volts).

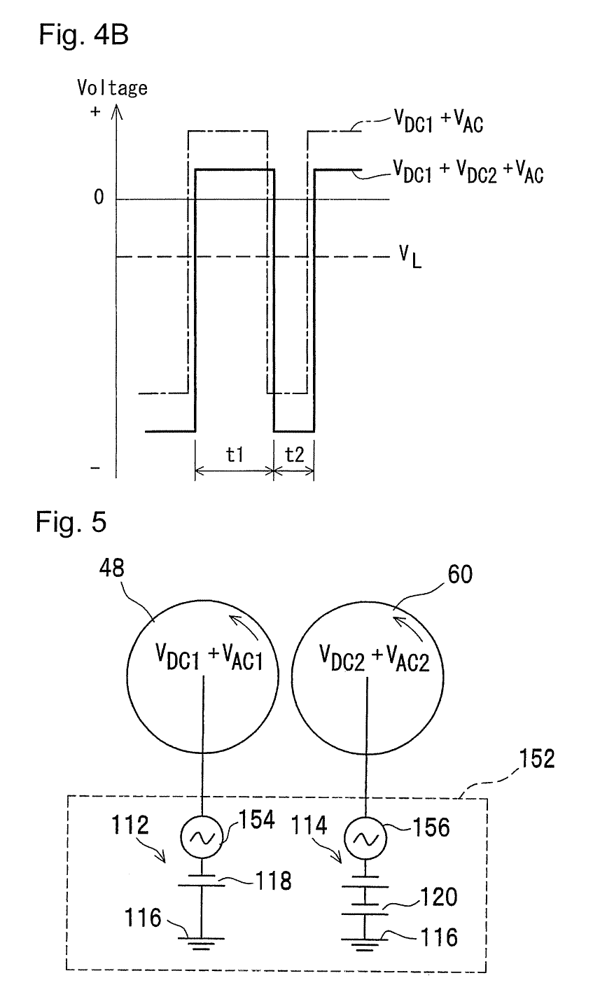

In the electric-field forming device 136 shown in FIG. 4A, a first power supply 138 (corresponding to a first electric-field forming means) is provided with a DC power supply 142 and an AC power supply 144 connected between the developing roller 48 and the ground 140. The DC power supply 142 applies a first DC voltage V_{DC1} (for example, −200 volts) having the same polarity as the electrostatic charge polarity of the toner to the sleeve 60 and the developing roller 48. The AC power supply 144 applies an AC voltage V_{AC} having an amplitude (peak-to-peak voltage V_{P-P}) of, for example, 1600 volts between the developing roller 48 and the ground 146 and between the sleeve 60 and the ground 146. A second power supply 146 (corresponding to a first electric-field forming means) has a DC power supply 150 connected between a terminal 148 between the developing roller 48 and the AC power supply 144, and sleeve 60. The DC power supply 150 can output a predetermined DC voltage V_{DC2}, with its anode being connected to the terminal 148 and its cathode being connected to the sleeve 60, so that the sleeve 60 is biased to the negative polarity relative to the developing roller 48 (see FIG. 4B). Therefore, within the supply area 90, the toner, charged to the negative polarity, is electrically attracted from the sleeve 60 to the developing roller 48 by the function of a pulsating-current electric field formed between the developing roller 48 and the sleeve 60. Within the developing area 96, the negative polarity toner on the developing roller 48 is allowed to adhere to an image portion of electrostatic latent image based upon a difference in electrical potentials between the developing roller 48 (V_{DC1}: −200 V) and the image portion of electrostatic latent image (V_{L}: −80 V).

An electric-field forming device 152 shown in FIG. 5 has a structure in which AC power supplies 154 and 156 are respectively added to the first power supply 112 and the second power supply 114 in the electric-field forming device 110 of embodiment 1 shown in FIG. 2A. The AC power supplies 154 and 156 respectively have output voltages of V_{AC1} and V_{AC2}. The voltages V_{AC1} and V_{AC2} may be the same or different from each other. An electric-field forming device 158 shown in FIG. 6 has a structure in which an AC power supply 160 is added to the first power supply 112 in the power supply of the embodiment shown in FIG. 2A. The AC power supply 160 has an output voltage of V_{AC}. In the same manner as in the electric-field forming devices 110, 122 and 136, each of the electric-field forming devices 152 and 158 of these embodiments supplies toner charged into the negative polarity from the sleeve 60 to the developing roller 48 in the supply area 90 by the function of a pulsating electric field formed between the developing roller 48 and the sleeve 60, and also supplies toner charged into the negative polarity from the developing roller 48 to the image portion of electrostatic latent image in the developing area 96, based upon a difference in electrical potentials relative to the image portion of electrostatic latent image (V_{L}: −80 V).

In the above-mentioned image-forming apparatus and developing device, when toner particles and a carrier make friction-contact with each other, the toner particles are charged into the negative polarity, while the carrier is charged into the positive polarity. Reverse polarity particles are charged into the positive polarity in contact with the carrier, while homopolarity particles are charged into the negative polarity in contact with the carrier. The electrostatic properties of the toner particles, carrier, reverse polarity particles and homopolarity particles are not intended to be limited by this combination. More specifically, another combination may be used. When toner particles and a carrier make friction-contact with each other, the toner particles is charged into the positive polarity, while the carrier is charged into the negative polarity, and reverse polarity particles are charged into the negative polarity in contact with the carrier, while homopolarity particles are charged into the positive polarity in contact with the carrier.

### EXAMPLES

The following description will discuss the present invention by means of examples; however, it is clear that the present invention should not be interpreted in a limited manner by the examples. The term “parts” refers to “parts by weight”.

Carrier A

Mg ferrite balls having a volume-average particle size of 50 μm were coated with polymethylmethacrylate resin by using a dry coating method so that a carrier A was prepared. The carrier had a dynamic current value of 0.3 μA and an average particle size of 53 μm. The saturated magnetization of the carrier was 50 μm²/kg.

Carrier B

Mg ferrite balls having a volume-average particle size of 50 μm were coated with silicone resin by using a spray coating method of a fluidizing layer system that a carrier B was prepared. The carrier had a dynamic current value of 0.5 μA and an average particle size of 51 μm. The saturated magnetization of the carrier was 50 Am²/kg.

Toner Particles

Toner particles were produced by using an emulsion polymerization association method. A styrene-acrylic copolymer was used as a binder resin for the toner particles. The toner particles had a volume-average particle size of 6.5 μm, an average roundness of 0.95 and a glass transition point of 50° C.

Toner; Externally Adding Method A

Toner particles and predetermined homopolarity particles were put in a Henschel mixer, and after having been mixed for 10 minutes, predetermined reverse polarity particles were added, and further mixed for 10 minutes.

Toner; Externally Adding Method B

Toner particles, predetermined homopolarity particles and reverse polarity particles were put in a Henschel mixer, and mixed for 20 minutes.

Reverse Polarity Particles

Magnesium titanate was used as reverse polarity particles, and classified so as to have a predetermined peak particle size for use.

Homopolarity Particles

Silica was used as homopolarity particles, and classified so as to have a predetermined peak particle size for use.

### Examples 1-8/Comparative Examples-8

Each of toners that were prepared by externally adding reverse polarity particles and homopolarity particles listed on Table 1 to toner particles in accordance with a predetermined externally adding method and a predetermined carrier were mixed so as to have a weight ratio of 10:90 in toner: carrier, so that a developer was obtained. The developer was put into an image-forming apparatus having a mode shown in FIG. 1. By using this image-forming apparatus, a sample having an image ratio of 5% were duplicated on 1 million sheets of paper. The toner was supplied every time the remaining amount became small.

The developing conditions were as follows: An electric-field forming device having a mode shown in FIG. 6 was used, a DC voltage V_{DC2}: −500 volts was applied to the transporting roller, and a DC voltage V_{DC1}: −300 volts and an AC voltage were applied to the developing roller. The AC voltage had a rectangular wave having a frequency: 2 kHz, an amplitude V_{P-P}: 1,600 volts, a minus duty ratio (toner recovery duty ratio): 40% and a plus duty ratio (toner supply duty ratio): 60%. The developing gap 50 was set to 0.3 mm, the supply/recovery gap 56 was set to 0.6 mm and the regulating unit was adjusted so that the developer transporting amount of the transporting roller was set to 50 mg/cm². The electrostatic charge potential (non-image portion) of the photosensitive member was −550 volts, and the electric potential of the electrostatic latent image (image portion) formed on the photosensitive member was −60 volts. The toner transporting amount of the developing roller was 5 g/m².

### Comparative Examples-9

The developer of Example 1 was put into a copying machine bizhub®C650 (produced by Konica Minolta Business Technologies, Inc.) of a two-component developing system and evaluated in a similar manner.

Image Density

After endurance printing processes, a solid image was printed, and the image density was measured. The image density was measured by using a transmission densitometer made by Macbeth Process Measurements Co.

### ⊚: Density≧1.5;

### ◯: 1.3≦Density<1.5;

Δ: 1.1≦Density<1.3 (problems raised in practical use);

### x: Density<1.1

Electrostatic Property

The quantities of charge of the reverse polarity particles, homopolarity particles and toner particles relative to a predetermined carrier were measured by using a blow-off method. More specifically, 20 parts by weight of the reverse polarity particles, homopolarity particles or toner particles and 80 parts by weight of a predetermined carrier were mixed with each other for a predetermined period of time, and the quantity of charge was measured by the blow-off method. The electrostatic property of the toner particles was measured before and after the endurance printing processes. The quantity of charge of magnesium titanate was +30 μC/g, and the quantity of charge of silica was −110 μC/g.

TABLE 1

| | | | | | | Toner particles | | | |
|---|---|---|---|---|---|---|---|---|---|
| | Reverse polarity particles | | Homopolarity particles | | | Electrostatic property μC/g | | | |
| | Peak | Amount | Peak | Amount | Externally | Before | After | | |
| | particle size | of addition | particle size | of addition | adding | endurance | endurance | Carrier | Image |
| | μm | Parts | μm | Parts | method | printing processes | printing processes | Type | density |
| Example. 1 | 0.2 | 0.5 | 0.015 | 1.0 | A | −33 | −30 | A | ⊙1.50 |
| Example. 2 | 0.1 | 0.5 | 0.015 | 1.0 | A | −38 | −27 | A | ◯1.30 |
| Example. 3 | 0.4 | 0.5 | 0.015 | 1.0 | A | −40 | −31 | A | ⊙1.50 |
| Example. 4 | 0.2 | 0.1 | 0.015 | 1.0 | A | −45 | −28 | A | ◯1.30 |
| Example. 5 | 0.2 | 1.9 | 0.015 | 1.0 | A | −30 | −29 | A | ⊙1.50 |
| Example. 6 | 0.2 | 0.5 | 0.006 | 1.0 | A | −47 | −30 | A | ⊙1.50 |
| Example. 7 | 0.2 | 0.5 | 0.04 | 1.0 | A | −32 | −30 | A | ⊙1.50 |
| Example. 8 | 0.2 | 0.5 | 0.015 | 0.11 | A | −29 | −25 | A | ◯1.30 |
| Example. 9 | 0.2 | 0.5 | 0.015 | 1.9 | A | −48 | −33 | A | ⊙1.50 |
| Example. 10 | 0.2 | 0.5 | 0.015 | 1.0 | A | −32 | −30 | B | ◯1.30 |
| Example. 11 | 0.2 | 0.5 | 0.015 | 1.0 | B | −30 | −28 | A | ◯1.40 |
| Comparative | 0.7 | 0.5 | 0.015 | 1.0 | A | −40 | −23 | A | Δ1.1 |
| Example. 1 | | | | | | | | | |
| Comparative | 0.07 | 0.5 | 0.015 | 1.0 | A | −28 | −20 | A | X1.0 |
| Example. 2 | | | | | | | | | |
| Comparative | 0.2 | 0.05 | 0.015 | 1.0 | A | −38 | −21 | A | X1.0 |
| Example. 3 | | | | | | | | | |
| Comparative | 0.2 | 2.5 | 0.015 | 1.0 | A | −27 | −20 | A | X1.0 |
| Example. 4 | | | | | | | | | |
| Comparative | 0.2 | 0.5 | 0.002 | 1.0 | A | −22 | −19 | A | X0.9 |
| Example. 5 | | | | | | | | | |
| Comparative | 0.2 | 0.5 | 0.07 | 1.0 | A | −27 | −21 | A | Δ1.1 |
| Example. 6 | | | | | | | | | |
| Comparative | 0.2 | 0.5 | 0.015 | 0.05 | A | −39 | −15 | A | X0.7 |
| Example. 7 | | | | | | | | | |
| Comparative | 0.2 | 0.5 | 0.015 | 2.3 | A | −45 | −24 | A | Δ1.2 |
| Example. 8 | | | | | | | | | |
| Comparative | 0.2 | 0.5 | 0.015 | 1.0 | A | −33 | −18 | A | Δ1.1 |
| Example. 9 | | | | | | | | | |

The electrostatic polarity is indicated by a blow-off quantity of charge relative to carrier.

Reference Signs List
10: Developer, 11: Image-forming apparatus, 12: Photosensitive member, 16: Charging station, 18: Exposing station, 20: Developing station, 22: Transferring station, 24: Cleaning station, 26: Charging device, 28: Exposing device, 30: Imaging light, 32: passage, 34: Developing device, 36: Transferring device, 38: Sheet, 40: Cleaning device, 42: Developer container (Housing), 44: Opening portion, 46: Second space, 48: Developing roller, 50: Developing gap, 52: Opening portion (Second space), 54: Transporting roller, 56: Supply/recovery gap, 58: Magnet, 60: Sleeve, 62: Regulating plate, 64: Regulating gap, 66: Developer stirring chamber, 68: Front chamber, 70: Rear chamber, 72: Front screw, 74: Rear screw, 76: Partition wall, 86: Regulating area, 88: Supply/recovery area, 90: Supply area, 92: Recovery area, 94: Releasing area, 96: Developing area, 98: Toner supply unit, 100: Holder, 102: Opening portion, 104: Supply roller, 110: Electric-field-forming device.

1. An image-forming method, comprising:
a process in which a toner is supported and transported on the surface of a toner supporting member placed face to face to an electrostatic latent image-supporting member, and electrostatic latent images formed on the latent image-supporting member is developed by the toner; and
a process in which a two-component developer containing the toner and a carrier is supported on the surface of a developer-supporting member placed face to face to the toner supporting member and the toner is supplied onto the toner-supporting member,
wherein the developer comprises:
toner particles containing a binder resin and a colorant;
a carrier that charges the toner particles in friction-contact with the toner particles;
reverse polarity particles that are charged to polarity reversed to polarity of the toner particles charged in friction-contact with the carrier; and
homopolarity particles that are charged to the same polarity as polarity of the toner particles charged in friction-contact with the carrier,
wherein the reverse polarity particles have a peak particle size in a range from 0.1 to 0.5 μm in the particle size distribution thereof, the reverse polarity particles have a content in a range from 0.1 to 2 parts by weight relative to 100 parts by weight of the toner particles, the homopolarity particles have a peak particle size in a range from 0.005 to 0.05 μm in the particle distribution thereof, and the homopolarity particles have a content in a range from 0.1 to 2 parts by weight relative to 100 parts by weight of the toner particles.

2. The image-forming method of claim 1, wherein the homopolarity particles are charged to the same polarity as the electrostatic charge polarity of the toner particles relative to the carrier, in friction-contact with the toner particles.

3. The image-forming method of claim 1, wherein the carrier has a dynamic current value in a range from 0.05 to 0.6 μA.

4. The image-forming method of claim 1, wherein the content of the homopolarity particles is set to 0.5 to 20 times as much as the content of the reverse polarity particles.

5. An image-forming apparatus, comprising the image-forming method of claim 1.

6. An image-forming apparatus, comprising the image-forming method of claim 2.

7. An image-forming apparatus, comprising the image-forming method of claim 3.

8. An image-forming apparatus, comprising the image-forming method of claim 4.
